(19) United States
(12) Patent Application Publication
(10) Pub. No.: US 2007/0120377 A1
(43) Pub. Date: May 31, 2007

(54) DEVICE FOR REVERSIBLY PREVENTING CLOSURE OF AN OVERHEAD DOOR

(76) Inventors: Jeff A. King, South Charleston, OH (US); Troy P. Romine, Springfield, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/564,073

(22) Filed: Nov. 28, 2006

Related U.S. Application Data
(60) Provisional application No. 60/740,852, filed on Nov. 29, 2005.

(51) Int. Cl. E05C 1/08

(52) U.S. Cl. 292/163

(57) ABSTRACT

A door retainage apparatus reversibly prevents closure of a track guided overhead door having a plurality of rollers. The apparatus includes a stopper formed to extend into, and retract from, the door track thereby permitting motion of at least one of the plurality of rollers in a first direction and preventing motion in a second direction, and an actuator for biasing the stopper such that the stopper retracts from an engaged position to an unengaged position as at least one of the plurality of rollers passes the stopper and then extends back to the engaged position. At least one stopper guide controls the motion of the stopper during transition from the engaged position to the unengaged position. A release device is adapted to selectively change the position of the stopper from the engaged position to the unengaged position.

### CROSS-REFERENCE TO RELATED APPLICATIONS

The present application claims priority benefit of U.S. Provisional Patent Application No. 60/740,852 filed on Nov. 29, 2005, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to door latches and, more particularly, to such an apparatus for ensuring that an overhead door placed in an opened position will maintain such position until released.

### BACKGROUND OF THE INVENTION

The ubiquitous overhead, or vertical, door is a functional feature of many residential, commercial, and industrial doorways. These doors are constructed of at least one door panel, most typically of a plurality of door panels, which are held in a track or other mounting hardware. To open the door, the door is propelled, either manually or mechanically, upwards from a closed to an open position. When the door is open, the panel or panels of the door are stored above the door opening, giving such doors and doorways the capacity for a wide and unobstructed opening than can easily be opened and closed, and that is capable of accommodating large items such as vehicles.

These doors can be quite large and heavy. To minimize the effective operating weight of the doors, they are frequently spring loaded or counterweighted such that a small bias remains towards the closed position when the door is closed, and a slight bias towards the open position is created when the door is open. However, these biases may be small, particularly the bias towards the open position when the door is open. Hence, it is not always difficult to propel the door, perhaps slightly, in a downward direction. Additionally, there is often a rebound effect when a door of this design is propelled upwards into the opened position. Reaching the end of the track or limits of the springs, thee is as tendency to rebound slightly, and if this rebound is sufficient to overcome the slight open bias when the door is in the opened position, the door may tend to return partially to the closed position. This leaves the door in a partially closed position.

Because these doors tend to be tall, it is easy for those working in this area of such a door to fail to notice that a door is partially closed. As a result, workers may drive high height clearance vehicles, such as for lifts, through such doorways, believing that the door is fully open, while in fact it is slightly displaced towards the closed condition. This can reduce the vertical height clearance sufficiently such that the vehicle strikes the door, damaging the door and potentially injuring persons in the door area. Those skilled in the art will recognize the relatively high frequency of repairs and replacements made to the lowest panels of overhead doors, precisely those that tend to be damaged in such accidents.

Various devices have been designed to hold overhead, or vertical, doors in a fixed open or shut position. Typical of these is U.S. Pat. No. 1,615,120 ('120) to Fischer. The '120 device utilizes a pair of sliding bolts, actuated by a cable mechanism, and cooperating bolt receivers in the door track, to lock a grain car door. This design has the clear drawback of requiring that the door be very closely aligned with the bolt receiving holes in order for the door to latch. While a plurality of receiving holes could be employed, it would impart only limited flexibility in that the bolts will still have to be precisely aligned with one of the sets of holes.

Many devices are also known to catch falling overhead, or vertical, doors, Typical of these is U.S. Pat. No. 2,095,695 ('695) to Greegor. The '695 device teaches a spring loaded pawl that, when actuated by the release of tension attendant to a breaking door cable or chain, jams against the door track, stopping the fall of the door. A similar device, utilizing a rotating cam to act as a pawl, is seen in U.S. Pat. No. 2,651,817 ('817) to Moler. These devices do not address the same problem as the instant invention, for while they are safety door latches, they act only in the case of a broken or otherwise suddenly released door tensioning apparatus. These devices would be at least partially, if not totally, ineffective against a slowly downward creeping door, or a door that, with tensioning mechanism fully intact, was simply not sufficiently raised to allow full clearance underneath; both such problems being addressed by the instant invention.

U.S. Pat. No. 3,258,062 ('062) to Lambert teaches a swing away member that can be pushed up and out of the way by a rising door, and is biased to return to a position preventing the door from passing back past the member. To close the door, the weight of the door must be unloaded from the member by slightly raising the door, and then the member is swung out of the way of the door wheels, s that the door can be lowered. This considerably complicates the process. In a power driven door, power would need to be engaged for a slight time to raise the door. The mechanism member would then have to be swung out of the way of the door wheels, and then power reversed to lower the door. It would be difficult to guess how far the door would need to be raised before it could be lowered. If the door were not raised sufficiently to cause the door wheels to fully pass the swinging members, on reversing the power to lower the door the operator would find the power mechanism firmly jamming the door wheels into the member, possibly damaging the door.

The instant invention addresses many of the shortcomings of the prior art and allows for previously unavailable benefits. A method and apparatus for preventing the unintended and possibly unnoticed partial closing of an overhead, or vertical, door has long been needed. The apparatus needs to be simple, reliable, inexpensive to fabricate, and easily retrofitted onto existing applications. The instant invention answers those needs.

### SUMMARY OF THE INVENTION

The present invention provides a door retainage apparatus which addresses at least some of the above-noted problems of the related art. According to the present invention, a door retainage apparatus reversibly prevents closure of a track guided overhead door having a plurality of rollers. The apparatus comprises a stopper formed to extend into, and retract from, the door track thereby permitting motion of at least one of the plurality of rollers in a first direction and preventing motion in a second direction, and an actuator for biasing the stopper such that the stopper retracts from an engaged position to an unengaged position as at least one of the plurality of rollers passes the stopper and then extends back to the engaged position. At least one stopper guide controls the motion of the stopper during transition from the engaged position to the unengaged position. A release device is adapted to change the position of the stopper from the engaged position to the unengaged position.

According to another aspect of the present invention, the apparatus comprises a stopper formed to extend into, and retract from, the door track thereby permitting motion of at least one of the plurality of rollers in a first direction and preventing motion in a second direction, and an actuator for biasing the stopper such that the stopper retracts from an engaged position to an unengaged position as at least one of the plurality of rollers passes the stopper and then extends back to the engaged position. At least one stopper guide controls the motion of the stopper during transition from the engaged position to the unengaged position. A release device is adapted to change the position of the stopper from the engaged position to the unengaged position. A housing is formed to releasably mount the apparatus to the door track and releasably retain the stopper, the actuator, and the at least one stopper guide.

According to yet another aspect of the present invention, a method for reversibly preventing closure of a track guided overhead door having a plurality of rollers, comprises the steps of providing a stopper formed to extend into, and retract from, the door track thereby permitting motion of at least one of the plurality of rollers in a first direction and preventing motion in a second direction, providing an actuator for biasing the stopper such that the stopper retracts from an engaged position to an unengaged position as at least one of the plurality of rollers passes the stopper and then extends back to the engaged position, providing at least one stopper guide to control the motion of the stopper during transition from the engaged position to the unengaged position, and providing a release device adapted to change the position of the stopper from the engaged position to the unengaged position.

From the foregoing disclosure and the following more detailed description of various preferred embodiments it will be apparent to those skilled in the art that the present invention provides a significant advance in the technology and art of door retainage devices. Particularly significant in this regard is the potential the invention affords for providing a high quality, reliable, low cost assembly which can be easily retrofitted into existing applications. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a side elevational view of an apparatus according to a preferred embodiment of the present invention, not to scale;

FIG. 2 is a plan view of the apparatus of FIG. 1, not to scale;

FIG. 3 is a cross sectional view of the apparatus of FIGS. 1 and 2, taken along line 3-3 of FIG. 2;

FIG. 4 is an elevational view showing installation of the apparatus of FIGS. 1 to 3 on a door, not to scale, wherein the door is in the closed position;

FIG. 5 is an elevational view similar to FIG. 4 but wherein the door in the up and secured position;

FIG. 6 is an enlarged, fragmented view taken from circle 6 of FIG. 5;

FIG. 7 is an elevational view similar to FIG. 5 but showing a variation of the apparatus;

FIG. 8 is a cross sectional view similar to FIG. 3 but showing a variation of the apparatus;

FIG. 9 is a cross sectional view similar to FIG. 3 but showing another variation of the apparatus; and

FIG. 10 is a cross sectional view similar to FIG. 3 but showing the apparatus in the unengaged position;

It should be understood that the appended drawings are not necessarily to scale, presenting a somewhat simplified representation of various preferred features illustrative of the basic principles of the invention. The specific design features of a retainage device as disclosed herein, including, for example, specific dimensions, orientations, locations, and shapes will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the devices illustrated in the drawings. In general, up or upward refers to an upward direction within the plane of the paper in FIG. 1 and down or downward refers to a downward direction within the plane of the paper in FIG. 1.

### DETAILED DESCRIPTION OF CERTAIN PREFERRED EMBODIMENTS

The method and apparatus for reversibly preventing the closure of an overhead door enables a significant advance in the state of the art. The preferred embodiments of the apparatus accomplish this by new and novel arrangements of elements and methods that are configured in unique and novel ways and which demonstrate previously unavailable but preferred and desire capabilities.

The description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is understood, however, that the same or equivalent functions and features may be accomplished by different embodiments that are also intended to be encompassed within the spirit and scope of the invention.

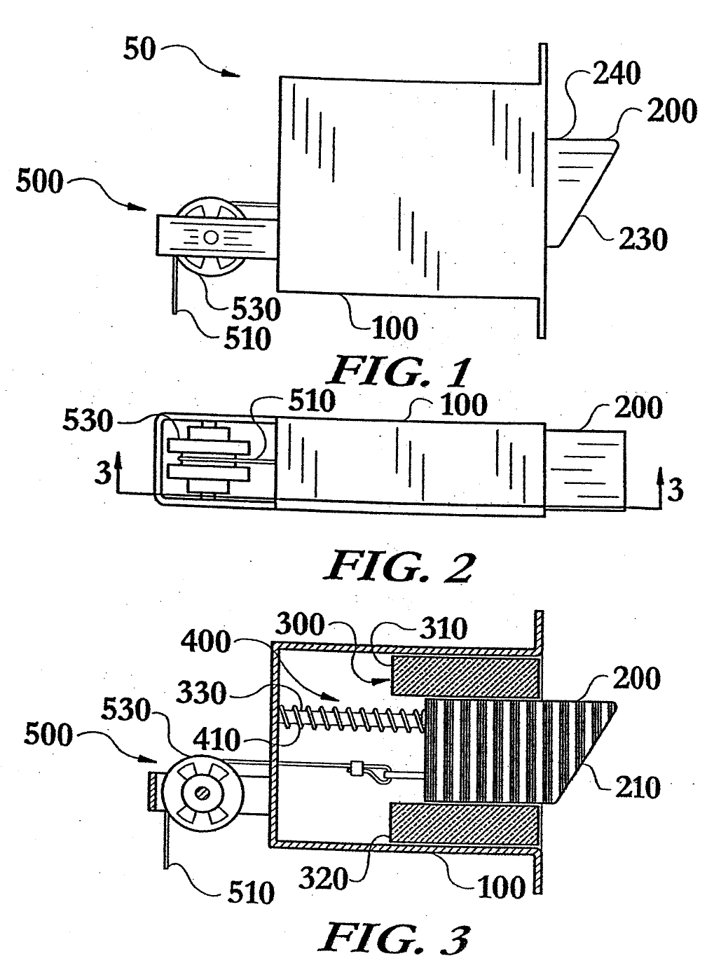

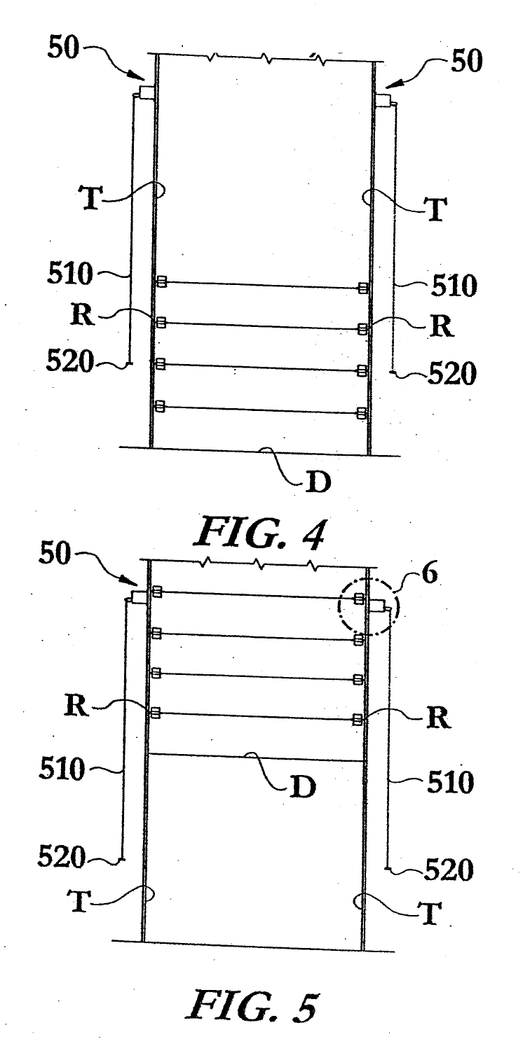

The door retainage apparatus 50 of the present invention comprises a stopper 200, an actuator 400, at least one stopper guide 300, a housing 100, and a release device 500, as illustrated in FIG. 1 through 3. The apparatus 50 is designed to prevent the accidental closure of overhead doors D having a number of rollers R that are guided in tracks T, as seen in FIG. 4. Such overhead doors D may be of the substantially vertical type or may be those that roll up into a horizontal position. In a typical overhead door arrangement, the apparatus 50 of the present invention would be applied to the door track T on each side of the door D, as seen in FIG. 5. The instant invention also contemplates that the apparatus 50 could operate independently pf a door D utilizing rollers R; that is, one skilled in the art would realize that the apparatus 50 could interact with some portion of a door D other than the rollers R, by way of example and not limitation, slides or some portion of the door D. One skilled in the art would also appreciate that the apparatus 50 could be mounted on the door D and interact with some portion of the track T or other part of the door D framing.

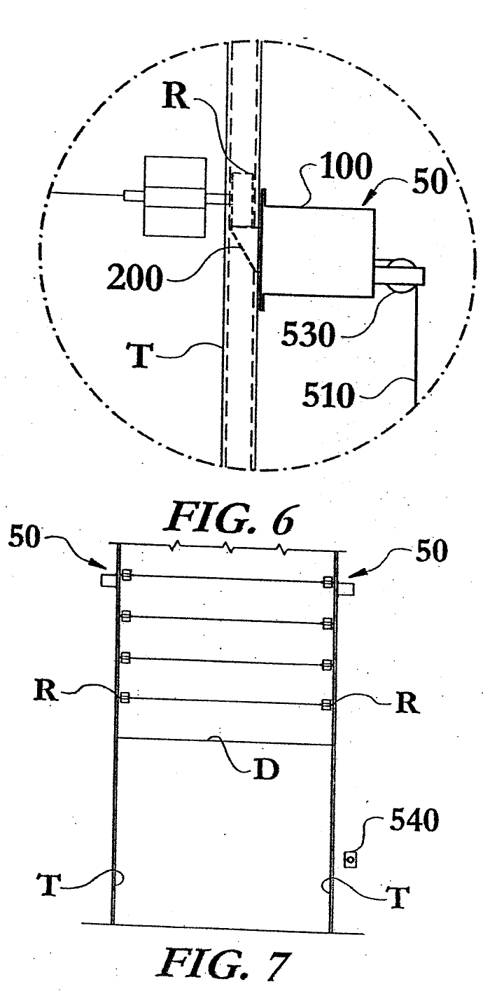

The housing 100 may be used to releasably mount the apparatus 50 to the track T in which the door rollers R ride, illustrated best in FIG. 6. Additionally, referring again to FIG. 3, the housing 100 serves to releasably retain the stopper 200, the actuator 400, and the at least one stopper guide 300. AS one with skill in the art can appreciate, the housing 100 may be virtually any shape and configuration, and may be made of virtually any durable material.

The stopper 200 is designed and formed to extend into, and retract from, the door track T. The stopper 200 is formed so that the motion of the door rollers R in a first direction, that required to open the door D, forces the stopper 200 to retract from an engaged position 210, as shown in FIG. 3, to an unengaged position 220, shown in FIG. 10, and allow the rollers R to pass, while the stopper 200 prevents motion of the door rollers R in a second direct ion, that required to close the door D. Generally, the housing 100 is mounted directly to the door track T and the stopper 200 extends into the track T through a hole.

Referring now to FIG. 1, in one particular embodiment, the stopper 200 is formed to have an angled impact surface 230 and a retainage surface 240. AS the door is raised, the rollers R contact the angles impact surface 230 thereby causing the stopper 200 to retract to the unengaged position 220. As the rollers R pass the stopper the actuator 400 causes the stopper 200 to extend back into the track T thereby preventing the rollers R, and therefore the door D, to pass the stopper 200 in the opposite direction.

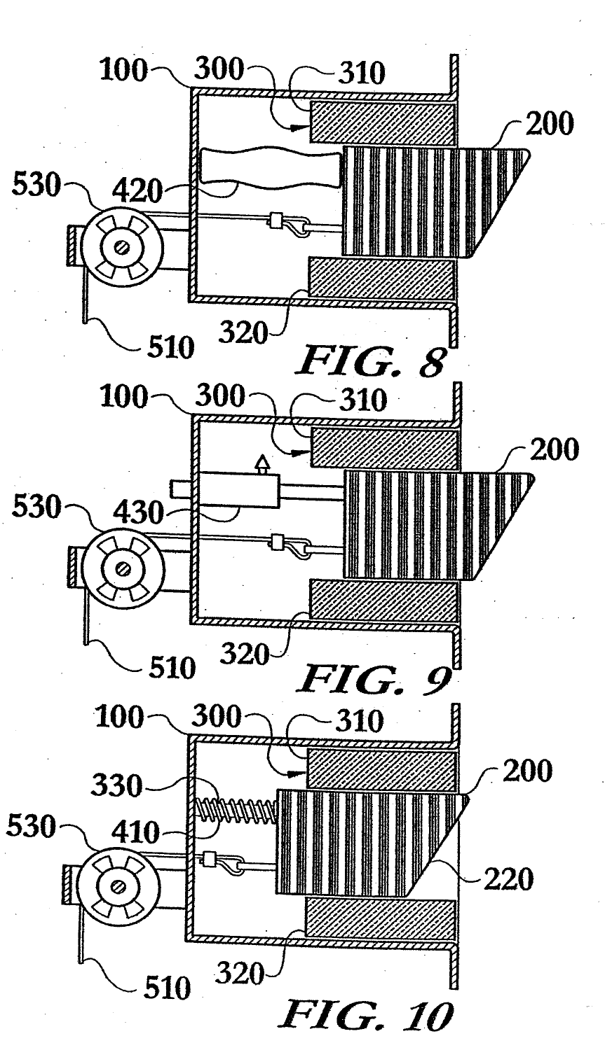

The actuator 400 serves to bias the stopper 200 such that the stopper 200 normally remains in an engaged position 210, shown best in FIG. 6, and only moves to an unengaged position 220 when acted upon by rollers R or the release device 500. Referring again to FIG. 3, due to the repeated abuse inflicted upon the stopper 200, the apparatus 50 may incorporate at least one stopper guide 300 to aide in the stopper's movement from the engaged position 210 to the unengaged position 220 and back again. In various embodiments the apparatus 50 may include an upper guide 310, a lower guide 320, and a longitudinal guide 330. Alternatively, the housing 100 may be formed to function as any, or all, of the at least one stopper guide 300. Additionally in some embodiments the actuator 400 and any of the at least one stopper guide 300 may be designed to work together, or even function as a single device. For example, certain embodiments having a guide rode type longitudinal guide 330 may include actuator 400 systems that are mounted to the longitudinal guide 330. One embodiment of the apparatus 50 may be formed such that the stopper 200 has a recess for receiving a fixed longitudinal guide 330 as the stopper 200 is retracted into the housing 100. As such, the longitudinal guide 330 is an ideal location to locate an actuator 400. FIG. 3 and FIG. 10 illustrate a spring actuator 410 mounted around the longitudinal guide 330. Similarly, in yet another embodiment, FIG. 8 illustrates an elastomeric actuator 420 mounted around the longitudinal guide 330. Lastly, FIG. 9 illustrates a fluid power actuator 430, be it pneumatic or hydraulic, that may function both as the actuator 400, or the biasing means, and as the longitudinal guide 330.

The function of the release device 500 is to allow a user to override the bias of the stopper 200 thereby allowing the door D to pass the stopper 200 in the second direction. In other words the release device 500 serves to retract the stopper 200 from the path of the roller R permitting the door D to return to a closed position. The release device 500 may be formed in any number of ways. In one particular embodiment shown in FIG. 3, the release device 500 comprises a cable 510 that is attached to the stopper 200 such that when a user pulls on the cable 510 the stopper 200 is retracted thus allowing the door D to lower. As seen in FIG. 4 and FIG. 5, this simple embodiment may include a handle 520 attached to the cable 510 to facilitate applying a tensile force to the cable 510. This embodiment may also include a rotary guide 530 to guide the cable 510 and minimize frictional forces. As one with skill in the art can appreciate, the release device 500 may also comprise a power release 540 illustrated in FIG. 7. Such an embodiment may include a conveniently located pushbutton that communicates, electrically or pneumatically, with the apparatus 50 to retract the stopper 200. In one such embodiment, the upper and lower guides 310, 320, shown best in FIG. 3, may include electromagnets that serve to retract the stopper 200 when energized, thereby ensuring that the door D is not inadvertently released upon the loss of power. Conversely, one with skill in the art would recognize that other embodiments may include a stopper 200 that is biased in the opposite direction, i.e. to the retracted, or unenergized, position 220.

Optionally, the action of the apparatus 50 could be coupled with mechanical, electrical, electronic, or other indicia to indicate the door D status, such as being locked in the open position or released to be lowered, to increase safety in the use of the apparatus 50.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and/or additional or alternative materials, relative arrangement of elements, and dimensional configurations. Accordingly, even though only a few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

What is claimed is:

1. A door retainage apparatus for reversibly preventing closure of a track guided overhead door having a plurality of rollers, comprising:
a stopper formed to extend into, and retract from, the door track thereby permitting motion of at least one of the plurality of rollers in a first direction and preventing motion in a second direction;
an actuator for biasing the stopper such that the stopper retracts from an engaged position to an unengaged position as at least one of the plurality of rollers passes the stopper and then extends back to the engaged position;
at least one stopper guide to control the motion of the stopper during transition from the engaged position to the unengaged position; and
a release device adapted to change the position of the stopper from the engaged position to the unengaged position.

2. The apparatus according to claim 1, wherein the stopper is formed to have an angled impact surface such that the impact of one of the plurality of rollers from the first direction automatically moves the stopper from the engaged position to unengaged position.

3. The apparatus according to claim 2, wherein the stopper is formed to have a retainage surface opposite the angled impact surface such that impact from one of the plurality of rollers from the second direction does not move the stopper from the engaged position to unengaged position.

4. The apparatus according to claim 1, wherein the actuator is a spring actuator.

5. The apparatus according to claim 1, wherein the actuator is an elastomeric actuator.

6. The apparatus according to claim 1, wherein the actuator is a fluid power actuator.

7. The apparatus according to claim 1, wherein the release device comprises at least one cable extending from the apparatus to a location that the cable can be activated by a person of ordinary height without any auxiliary aides.

8. The apparatus according to claim 7, wherein the cable is provided with a handle for manually pulling the cable.

9. The apparatus according to claim 7, wherein a rotary guide is provided to guide the cable.

10. The apparatus according to claim 1, wherein the release device is a power release device.

11. The apparatus according to claim 10, wherein a pushbutton is in communication with the power release device to move the stopper from the engaged position to unengaged position

12. The apparatus according to claim 1, wherein the at least one stopper guide includes a longitudinal guide.

13. The apparatus according to claim 12, wherein the actuator is mounted about the longitudinal guide.

14. The apparatus according to claim 12, wherein the at least one stopper guide includes upper and lower guides.

15. The apparatus according to claim 12, further comprising a housing formed to releasably mount the apparatus to the door track and releasably retain the stopper, the actuator, and the at least one stopper guide.

16. A door retainage apparatus for reversibly preventing closure of a track guided overhead door having a plurality of rollers, comprising:
a stopper formed to extend into, and retract from, the door track thereby permitting motion of at least one of the plurality of rollers in a first direction and preventing motion in a second direction;
an actuator for biasing the stopper such that the stopper retracts from an engaged position to an unengaged position as at least one of the plurality of rollers passes the stopper and then extends back to the engaged position;
at least one stopper guide to control the motion of the stopper during transition from the engaged position to the unengaged position;
a housing formed to releasably mount the apparatus to the door track and releasably retain the stopper, the actuator, and the at least one stopper guide; and
a release device adapted to change the position of the stopper from the engaged position to the unengaged position.

17. The apparatus according to claim 16, wherein the stopper is formed to have an angled impact surface such that the impact of one of the plurality of rollers from the first direction automatically moves the stopper from the engaged position to unengaged position.

18. The apparatus according to claim 17, wherein the stopper is formed to have a retainage surface opposite the angled impact surface such that impact from one of the plurality of rollers from the second direction does not move the stopper from the engaged position to unengaged position.

19. The apparatus according to claim 18, wherein the at least one stopper guide includes a longitudinal guide.

20. A method for reversibly preventing closure of a track guided overhead door having a plurality of rollers, comprising the steps of:
providing a stopper formed to extend into, and retract from, the door track thereby permitting motion of at least one of the plurality of rollers in a first direction and preventing motion in a second direction;
providing an actuator for biasing the stopper such that the stopper retracts from an engaged position to an unengaged position as at least one of the plurality of rollers passes the stopper and then extends back to the engaged position;
providing at least one stopper guide to control the motion of the stopper during transition from the engaged position to the unengaged position; and
providing a release device adapted to change the position of the stopper from the engaged position to the unengaged position.
